(19) United States
(12) Patent Application Publication
(10) Pub. No.: US 2023/0376796 A1
(43) Pub. Date: Nov. 23, 2023

(54) METHOD AND SYSTEM FOR KNOWLEDGE-BASED PROCESS SUPPORT

(71) Applicant: NEC Laboratories Europe GmbH, Heidelberg (DE)

(72) Inventor: Tobias JACOBS, Heidelberg (DE)

(21) Appl. No.: 18/030,292

(22) PCT Filed: Feb. 17, 2021
(86) PCT No.: PCT/EP2021/053927

§ 371 Date: Apr. 5, 2023

(30) Foreign Application Priority Data
Feb. 5, 2021 (EP) 21155595.8

(51) Int. Cl. G06N 5/022; G06N 20/00

(52) U.S. Cl. CPC G06N 5/022; G06N 20/00

(57) ABSTRACT

A method for knowledge-based process support, and a process model is related to the process. The method includes providing an event log of event data related to process events by a data mining tool. The method also includes exploiting semantic information contained in the process events or event log by computing a representation of the events, the process model, and semantic information as a common knowledge graph, and using the knowledge graph in graph-based machine learning for the support of the process.

### CROSS REFERENCE TO RELATED APPLICATIONS

This application is a U.S. National Phase application under 35 U.S.C. § 371 of International Application No. PCT/EP2021/053927, filed on Feb. 17, 2021, and claims benefit to European Patent Application No. EP 21155595.8, filed on Feb. 5, 2021. The International Application was published in English on Aug. 11, 2022 as WO 2022/167102 A1 under PCT Article 21(2).

### FIELD

The present invention relates to a method and system for knowledge-based process support, wherein a process model is related to the process.

### BACKGROUND

Corresponding prior art documents are listed as follows:
[1] Ana Karla Alves de Medeiros, Wil Van der Aalst, and Carlos Pedrinaci. Semantic process mining tools: Core building blocks. 2008.
[2] Stierle, Matthias, et al. “A Technique for Determining Relevance Scores of Process Activities using Graph-based Neural Networks.” arXiv preprint arXiv:2008.03110 (2020).
[3] Ontology Core Process Mining, as it appears in the Search Report under Reference 2.

Process Mining is a data-mining discipline where real-world event data, recorded during the automatic or manual execution of processes, is analyzed in light of abstract process models. The most common tasks of process mining tools are (a) creation of process models from event logs, and (b) conformance checking of event logs against given process models.

Existing process mining tools make use of the following three basic attributes of events:
Case ID, an identifier of the process execution instance the event relates to—e.g. a particular booking number in a car rental system.
Timestamp
Activity type, describing the type of activity the event relates to, e.g. “request for cancellation issued”.

The two above-mentioned traditional tasks of process mining tools—creation of process models and conformance checking—can be performed using only these three attributes. However, there is a variety of further applications of process models and event data, including
(1) prediction of future events and their attributes, and
(2) prescription of future activities

In the related work of De Medeiros et al. [1], it is proposed to annotate activities with links into ontologies to clarify their meaning. However, this limited form of semantic enrichment does not exploit the full potential of event data and targets interoperability rather than prediction and prescription of events.

In further related work [2] the authors analyze process graphs using Graph Neural Networks to learn predictors for process performance. However, in that work the input is restricted to the graphs of the process model and does not take into account additional data of the event.

In further related work [3] the authors propose to annotate the elements of process graphs with ontology concepts and then perform semantic reasoning to extract new knowledge about the processes. While Ontologies provide useful information about the meaning of event attributes and process elements, the information is restricted to generic domain information. Furthermore, such domain ontologies have to be hand-crafted, which is tedious and error-prone.

### SUMMARY

In an embodiment, the present disclosure provides a method for knowledge-based process support, and a process model related to the process. The method comprises: providing an event log of event data related to process events by a data mining tool, exploiting semantic information contained in the process events or event log by computing a representation of the events, the process model, and semantic information as a common knowledge graph, and using the knowledge graph in graph-based machine learning for the support of the process.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows in a diagram a workflow of an embodiment of the method for knowledge-based process support according to the invention; and

FIG. 2 shows in a diagram a structure of an embodiment of the KnFG explained in FIG. 1.

### DETAILED DESCRIPTION

In accordance with an embodiment, the present invention improves and further develops a method and system for knowledge-based process support for providing applicability of the method and system for a large number of applications together with a use of additional meaningful data by simple means.

In accordance with another embodiment, the present invention provides a method for knowledge-based process support, wherein a process model is related to the process, comprising the following steps:
providing an event log of event data related to process events by a data mining tool,
exploiting semantic information contained in the process events or event log by computing a representation of the events, the process model, and semantic information as a common knowledge graph, and
using the knowledge graph in graph-based machine learning for the support of the process.

Further, in accordance with another embodiment, the present invention provides a system for knowledge-based process support, preferably for carrying out the method for knowledge-based process support, wherein a process model is related to the process, comprising:
a data mining tool for providing an event log of event data related to process events,
computing means for exploiting semantic information contained in the process events or event log by computing a representation of the events, the process model, and semantic information as a common knowledge graph, and
computing means for using the knowledge graph in graph-based machine learning for the support of the process.

According to the invention it has been recognized that it is possible to provide applicability of the method and system for a large number of applications by simply exploiting semantic information contained in the process events or event log. In a further inventive step and for exploiting this semantic information a representation of the events, the process model and semantic information is computed as a common knowledge graph. It has been further recognized that this knowledge graph can be used in a very smart way in graph-based machine learning for providing an efficient support of the process. Thus, a combination of prior art data mining with semantic knowledge representation is provided resulting in the possibility of an enlarged applicability of the method and system for a large number of applications.

Thus, on the basis of the invention applicability of the method and system for a large number of applications together with a use of additional meaningful data by simple means is provided.

According to an embodiment of the invention the data mining tool can provide process mining. Process mining is a data-mining discipline being very suitable for analyzing real-world process event data in light of abstracted process models.

Within a further embodiment the support can comprise prediction of at least one future event and/or at least one attribute of such a future event or future events. In a further embodiment the at least one attribute can be used to allocate resources prior to their usage by a future event or future events. This provides a very effective support of a process.

In a further embodiment and alternatively or additionally to the above feature the support can comprise a prescription and/or recommendation of a future process behavior and/or future event and/or future activity.

For those types of applications, applicability of state-of-art process mining tools is limited, as they restrict the input to the above mentioned three basic attributes and thus cannot make use of additional meaningful data.

For example, in an application to resource allocation in a cloud computing system may estimate the memory needs of a future computation. The activity type, e.g. “optimize model” might not reveal enough information for a good estimation of the memory needs. However, context or semantic information about the type of model and the amount of data could be used to make more accurate estimations.

Performance data—waiting time, cost, etc.—is taken into account in performance mining, but the application is limited to the target of identifying performance improvement opportunities for processes.

Within a further embodiment the support can be used in automated decision making and/or predictive resource allocation for the process. These are two important fields of application of embodiments of the method and system for knowledge-based process support.

Within a further embodiment the method can comprise combining an event flow graphifier with a knowledge base, KB, matcher. Thus, a very structured proceeding can be provided. The event flow graphifier can operate on the basis of a specific algorithm.

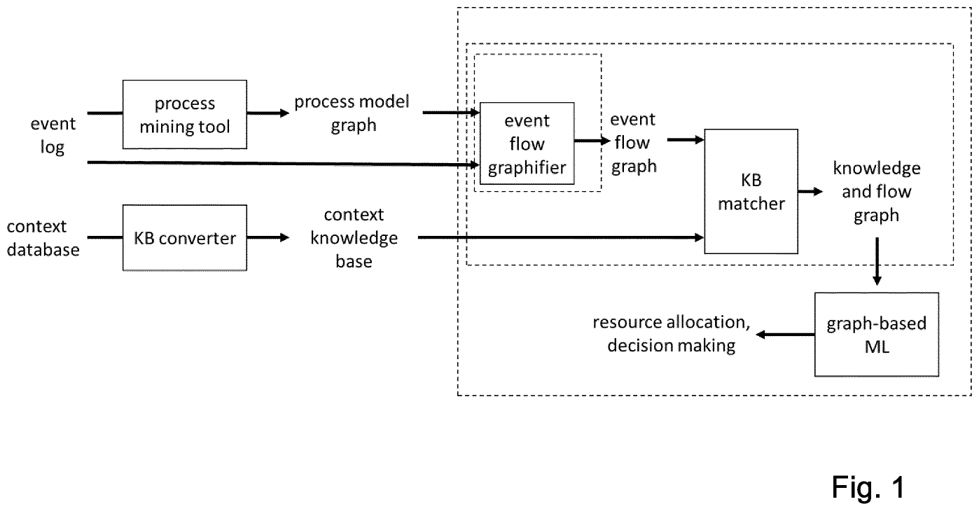

According to a further embodiment computing the representation can comprise a use of an event flow graphifier wherein events or raw events and a process model graph are represented as graph nodes. In a further embodiment the events or raw events and a process model graph can be inter-linked via at least one common activity type, see also steps 2 and 3 of the event flow graphifier algorithm in the description of FIG. 1 of this document, and/or via a mapping of event sequences conforming to the process model, see also step 4.3 of the event flow graphifier algorithm in the description of FIG. 1 of this document.

Within a further embodiment an event flow graph can be created from the event log and a process model graph. For performing this creation an event flow graphifier algorithm can be used.

According to a further embodiment a knowledge base, KB, matcher is applied to an event flow graph and context knowledge base to create the common knowledge graph or a knowledge and flow graph, KnFG. In a further embodiment the event flow graph and the knowledge base can be unified using the knowledge base, KB, matcher, which can identifies equivalence relations between entities of these two inputs provided by the event flow graph and the knowledge base.

In a further embodiment the knowledge graph or knowledge and flow graph, KnFG, can be a machine-readable representation of recorded event flows, their generalization in form of a process model and the semantic information. Such a machine-readable representation can be used within the method and system for knowledge-based process support in a simple way.

According to a further embodiment the knowledge graph or knowledge and flow graph, KnFG, can admit the application of the graph-based machine learning for link prediction, node classification and node attribute prediction in the graph. These are important fields of application of the method and system for knowledge-based process support.

Advantages and aspects of embodiments of the present invention are summarized as follows:

Prior art process mining tools automatically analyze real-world process event data in light of abstracted process models, with the target of data-driven process model creation and maintenance, as well as conformance checking of event data against process models. Embodiments of this invention exploit semantic information contained in the event log, which is performed by computing a representation of the events, the process model, and additional context information as a common knowledge graph. The resulting semantically enriched process and event data enable applications of graph-based machine learning for a variety of tasks, such as automated decision making and predictive resource allocation.

Embodiments of this invention make use of the fact that real-world event data often has many attributes which provide valuable information, and which themselves can be the target of prediction and recommendation tasks. Furthermore, additional structured—relational or graph-structured—data providing additional context for the attributes is often available in the databases of the organizations that apply process mining. Embodiments of this invention combine state-of-art process mining with semantic knowledge representation, enabling the application of state-of-art machine learning tools for making both predictions and prescriptions of events, making use of all available event and context information.

Further advantages and aspects of embodiments of the present invention are summarized as follows:
1) Embodiments can integrate event log, process model graph, and context knowledge base into a unified graph for application of graph-based machine learning for applications of resource allocation and automated decision making
2) A specific workflow of combining event flow graphifier with a knowledge base matcher can be provided, see also inside the dashed box in FIG. 1.
3) A specific algorithm of event flow graphifier as described above can be provided, where both the raw events and the abstracted process model graph are represented as graph nodes, and they can become inter-linked in two ways: via common activity types, see also steps 2 and 3 of the event flow graphifier algorithm in the description of FIG. 1 of this document, and via the mapping of event sequences conforming to the model, see also step 4.3 of the event flow graphifier algorithm in the description of FIG. 1 of this document.

Embodiments of this invention provide a method for resource allocation or decision making comprising the steps of
1) Using an event flow graphifier algorithm to create an event flow graph from an event log and a process model graph
2) Applying a knowledge base matcher to the event flow graph and the context knowledge base to create the KnFG
3) Training with the KnFG a graph-based machine learning model for predicting attributes of event entities
4) Using the predicted attributes, for example, to allocate resources prior to their usage by future events.

Embodiments of the invention take into account full semantic information for predictions in process or event-based systems, including event log, process model, and context information. This leads to more accurate predictions as opposed to just using the minimal event data as done in state-of-art process mining.

There are several ways how to design and further develop the teaching of the present invention in an advantageous way. To this end it is to be referred to the following explanation of examples of embodiments of the invention, illustrated by the drawing.

A workflow of an embodiment of the invention is shown in FIG. 1. Graph-based machine learning is applied to a Knowledge and Flow Graph, KnFG, constructed in a sequence of steps. The KnFG is a unified machine-readable representation of recorded event flows, their generalization in form of a process model, and an additional context knowledge or an additional semantic information.

We assume that we are given an event log, where each event contains
case ID, timestamp and activity type as described in the preceding section
one or more additional attributes of the form <attribute id, attribute value>, where the attribute value is either numerical or categorical

The other input we assume is a context database containing semantic information or context information with regard to the event log. For example, semantic information or context information could relate to resources needed for activities, energy usage of these activities, and the owners of these resources. Technically the context database contains information related to categorical attribute values of events, including but not limited to the case ID.

A Knowledge Base, KB, converter is applied to convert the database into a context knowledge base, which is a graph-structured representation of the context data, consisting of entities with their attributes and relations between the entities. In that knowledge base, the context of the event log is stored by entities representing attribute values of events, including but not limited to the case ID. In some embodiments or applications the context database might already be represented in form of a knowledge base from the start; making the KB converter obsolete.

Using a state-of-art process mining tool, a process model graph is constructed from the event log. All or a subset of the nodes in the process model graph represent activities and, like events, they have an activity type. Edges express temporal dependencies between the activities. There are several kinds of process model graphs with several levels of semantics and expressiveness, including Petri Nets, Business Process Model and Notation, BPMN, graphs, or dependency graphs. This invention is not limited to any particular type or notation of process model graphs.

The relationship between the event log and the constructed process model graph is as follows: For any case ID, the corresponding event sequence is the list of events from the event log having the given case ID, where the list is ordered by event timestamp. An event sequence conforms to a process model graph when there is a mapping of the events to graph nodes, such that (a) the activity type of each event matches the activity type of the node it is mapped to, and (b) the resulting sequence of graph nodes does not violate any of the dependencies expressed by the edges. State-of-art process mining tools are designed in such a way that they create a process model where the large majority of event sequences from the log conform to.

Given the event log and the process model graph, an event flow graphifier creates the event flow graph, which is a representation of both the event log and the process model graph in form of a knowledge base:

Event Flow Graphifier Algorithm:
1. Create entity set PN, containing an entity for each node in the process model graph, and create links between entities in PN according to the edges in the process model graph.
2. Create entity set AT, containing an entity for each distinct activity type, and add a relation between each element of PN and the entity in AT corresponding to its activity type.
3. Create entity set E, containing an entity for each event, and insert a relation with the corresponding activity type entity in AT.
4. Create entity set ID: for each event sequence corresponding to some case ID,
   4.1. Insert a relation between each pair of entities in E corresponding to subsequent events in the sequence,
   4.2. Insert an entity into ID representing the case ID, create relations to all events in E that appear in the sequence,
   4.3. if the event sequence conforms to the process model graph, represent the mapping between the events and the process model nodes by relations between the corresponding process node entities in PN and event entities in E.
5. Create entity set A, containing, an entity for each value of a categorical attribute of an event, and insert a relation between the corresponding entity in E and the entity in A.

Finally, the event flow graph and the knowledge base are unified using a KB matcher, which is identifying equivalence relations between entities of the two inputs. It is possible to either merge equivalent entities or to insert relations between any pair of equivalent entities, obtaining the Knowledge and Flow Graph, KnFG.

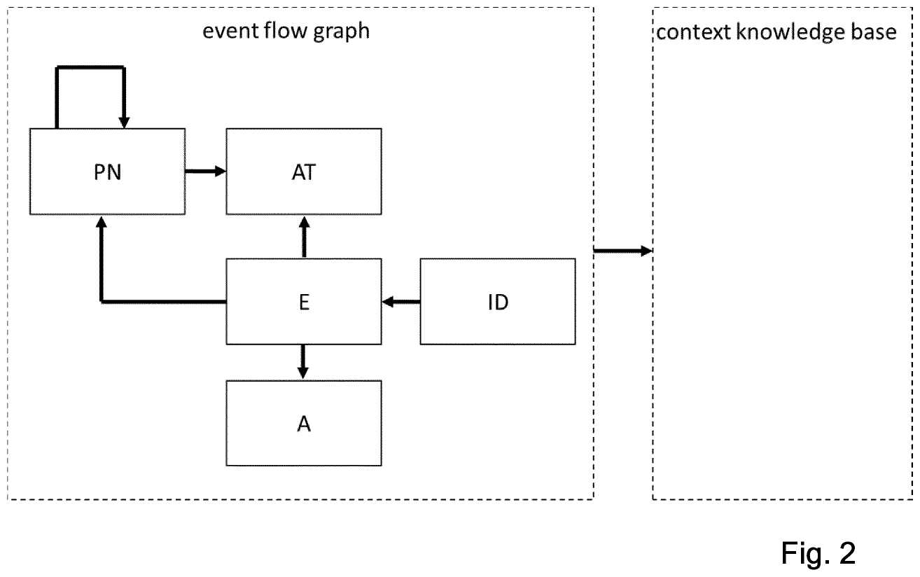

The structure of the KnFG is depicted in FIG. 2, where arrows inside the event flow graph represent relations that are created by the event flow graphifier, and the links between the event flow graph and the context knowledge base are inserted using the KB matcher.

Further enrichment of the event flow graph is possible, for example:
For each numerical attribute value of an event, an attribute having the same name and value is added to the corresponding event entity from E.
Each of the above-mentioned relations is assigned a distinct relation type.

### Technical Applications

According to an embodiment of the invention, the KnFG is a machine-readable representation of the events, the process model, and the contextual information. In particular it admits application of graph-based machine learning methods for link prediction, node classification, and node attribute prediction in the unified graph. We list below some examples of the technical applications.
Automated Resource Allocation is a technical effect realized by automatically reserving resources for processes in the future. By predicting properties of future events—which corresponds to node classification or link prediction in the KnFG—information about the resource requirements of the activity related to the event is obtained. Examples of such resources are
   computational resources—processing power, memory—for activities that correspond to computational tasks,
   data resources—pre-fetching data-sets or documents from a remote server) for activities that may require data, such as training a machine learning model or inserting a report into a document,
   energy that may be required for activities like a robot performing a task, or using a manufacturing device, where the energy can be automatically reserved from a storage like a battery, or the energy can be automatically purchased from the energy marked,
   devices which need some time to become ready for an activity, like pre-heating an oven or starting a computer,
   physical goods that may be required for an activity and need some time to be fetched from an automated warehouse or storage.
Automated Decision Making is a technical effect realized by deciding on one or more attribute values—including but not limited to the activity type—of a future event. This corresponds either to a node classification or a link prediction task in the KnFG. Examples of such decisions are
   robots deciding on the most promising next step of a complex task,
   reminders and information—e.g. bills, offers—being sent to users of a process management platform,
   inspection and testing applied to individual manufactured goods in production processes when needed,
   assignment of data sensitiveness levels to processed documents, influencing their storage and access rules.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for knowledge-based process support, wherein a process model is related to the process, the method comprising:
providing an event log of event data related to process events by a data mining tool;
exploiting semantic information contained in the process events or event log by computing a representation of the events, the process model, and semantic information as a common knowledge graph; and
using the knowledge graph in graph-based machine learning for the support of the process.

2. The method according to claim 1, wherein the data mining tool provides process mining.

3. The method according to claim 1, wherein the support comprises prediction of at least one future event and/or at least one attribute of such a future event or future events.

4. The method according to claim 3, wherein the at least one attribute is used to allocate resources prior to the usage of the resources by a future event or future events.

5. The method according to claim 1, wherein the support comprises a prescription and/or recommendation of a future process behavior and/or future event and/or future activity.

6. The method according to claim 1, wherein the support is used in automated decision making and/or predictive resource allocation for the process.

7. The method according to claim 1, wherein the method comprises combining an event flow graphifier with a knowledge base (KB) matcher.

8. The method according to claim 1, wherein computing the representation comprises a use of an event flow graphifier wherein events or raw events and a process model graph are represented as graph nodes.

9. The method according to claim 8, wherein the events or raw events and the process model graph are inter-linked via at least one common activity type and/or via a mapping of event sequences conforming to the process model.

10. The method according to claim 1, wherein an event flow graph is created from the event log and a process model graph.

11. The method according to claim 1, wherein a knowledge base (KB) matcher is applied to an event flow graph and context knowledge base to create the common knowledge graph or a knowledge and flow graph (KnFG).

12. The method according to claim 11, wherein the event flow graph and the knowledge base are unified using the knowledge bases (KB) matcher.

13. The method according to claim 11, wherein the knowledge graph or knowledge and flow graphs (KnFG) is a machine-readable representation of recorded event flows, generalization of the recorded event flows in form of a process model and the semantic information.

14. The method according to claim 1, wherein the knowledge graph or knowledge and flow graphs (KnFG) admits the application of the graph-based machine learning for link prediction, node classification and node attribute prediction in the graph.

15. A system for knowledge-based process support, wherein a process model is related to the process, the system comprising:
a data mining tool for providing an event log of event data related to process events,
computing means for exploiting semantic information contained in the process events or event log by computing a representation of the events, the process model, and semantic information as a common knowledge graph, and
computing means for using the knowledge graph in graph-based machine learning for the support of the process.

16. The method according to claim 12, wherein the knowledge base identifies equivalence relations between entities of inputs provided by the event flow graph and the knowledge base.
